(19) United States
(12) Patent Application Publication
(10) Pub. No.: US 2018/0126965 A1
(43) Pub. Date: May 10, 2018

(54) VEHICLE CONTROL DEVICE, VEHICLE CONTROL METHOD, AND VEHICLE CONTROL PROGRAM

(71) Applicant: HONDA MOTOR CO., LTD, Tokyo (JP)

(72) Inventor: Kanta Tsuji, Utsunomiya-shi (JP)

(21) Appl. No.: 15/791,546

(22) Filed: Oct. 24, 2017

(30) Foreign Application Priority Data
Nov. 4, 2016 (JP) 2016-216355

(51) Int. Cl. B60T 7/22; B60T 8/32; B60T 8/24; B60T 8/172

(52) U.S. Cl. CPC B60T 7/22; B60T 8/3205; B60T 8/245; B60T 2201/022; B60T 2201/06; B60T 2210/32; B60T 2210/20; B60T 8/172

(57) ABSTRACT

A vehicle control device, method, and a vehicle control program capable of controlling a vehicle with good responsiveness. The vehicle control device includes: a surrounding situation recognizer configured to recognize a situation in an advancing direction of a vehicle; and an automatic brake controller configured to cause a brake device to apply a brake force in accordance with the situation in the advancing direction of the vehicle recognized by the surrounding situation recognizer and is configured to cause the brake device to release the brake force at a time of accelerating the vehicle, in which when the vehicle is decelerating, the automatic brake controller configured cause a brake device to release the brake force in response to an increase in vehicle speed of the vehicle when the vehicle is subject to acceleration control or an acceleration operation before stopping.

### CROSS-REFERENCE TO RELATED APPLICATION

Priority is claimed on Japanese Patent Application No. 2016-216355, filed Nov. 4, 2016, the content of which is incorporated herein by reference.

### BACKGROUND

### Field of the Invention

The present invention relates to a vehicle control device, a vehicle control method, and a vehicle control program.

### Description of Related Art

In the related art, a brake control device of a vehicle which controls a brake force applied to wheels of the vehicle including a power source, in which the brake control device of the vehicle includes a brake force control means for controlling a brake force used to maintain a stopped state of the vehicle before a start of the vehicle using a driving force transmitted from the power source to the wheels by braking a wheel having small driving force without braking a wheel having a large driving force is known (for example, Japanese Unexamined Patent Application, First Publication No. 2006-199154).

### SUMMARY

However, in the technique disclosed in the above Patent Document 1, when the vehicle stops due to an output of a brake force once and then a driving force reaches a value for starting the vehicle, it was felt that responsiveness was bad in some cases depending on a situation in which the vehicle is placed because the brake force is released.

The present invention was made in view of such circumstances, and an objective thereof is to provide a vehicle control device, a vehicle control method, and a vehicle control program capable of controlling a vehicle with good responsiveness.

A vehicle control device according to an aspect of the present invention includes: a surrounding situation recognizer configured to recognize a situation in an advancing direction of a vehicle; and an automatic brake controller configured to cause a brake device to apply a brake force in accordance with the situation in the advancing direction of the vehicle recognized by the surrounding situation recognizer and is configured to cause the brake device to release the brake force at a time of accelerating the vehicle, in which when the vehicle is decelerating, the automatic brake controller is configured to cause a brake device to release the brake force in response to an increase in vehicle speed of the vehicle when the vehicle is subject to acceleration control or an acceleration operation before stopping.

In the vehicle control device described above, further comprising an acquirer is configured to acquire information on a gradient of a road on which the vehicle is placed, wherein the automatic brake controller is configured to cause the brake device to apply a brake force used to suppress backward movement of the vehicle when the vehicle is located on an upward slope.

In the vehicle control device described above, the automatic brake controller is configured to cause the brake device to apply a brake force to correspond to behavior of an object in an advancing direction of the vehicle which is recognized by the surrounding situation recognizer, and is configured to cause the brake device to release the brake force in response to an increase in vehicle speed of the vehicle when the acceleration control or the acceleration operation performed on the vehicle in response to a start of acceleration of the object.

In the vehicle control device described above, the automatic brake controller is configured to cause, when the vehicle is stopped, the brake device to release the brake force when a driving force of the vehicle exceeds a predetermined value due to the acceleration control or the acceleration operation, and is configured to cause, before the vehicle is stopped, the brake device to release the brake force in response to an increase in vehicle speed of the vehicle when the acceleration operation or the acceleration control is performed on the vehicle.

In the vehicle control device described above, the automatic brake controller is configured to cause the brake device to apply a brake force to stop the vehicle to correspond to a stop of a preceding vehicle located in the advancing direction of the vehicle and traveling in the same direction as the vehicle which is recognized by the surrounding situation recognizer.

In the vehicle control device described above, the automatic brake controller is configured to determine that the preceding vehicle has started when a distance from the vehicle to the preceding vehicle is a predetermined distance or more.

In the vehicle control device described above, further comprising: further comprising an acquirer configured to acquire information on a gradient of a road on which the vehicle is placed, the automatic brake controller is configured to cause the brake device to release the brake force before a power source of the vehicle outputs a driving force, which is equivalent to a force causing the vehicle to move backward caused due to the upward slope, to start the vehicle when the vehicle is subject to the acceleration control or the acceleration operation before stopping while decelerating.

In the vehicle control device described above, the brake force is gradually released after the vehicle has been subjected to the acceleration control or the acceleration operation before stopping while decelerating and increases a weakening amount per time of the brake force as compared to before a vehicle speed of the vehicle increases.

A vehicle control device according to an aspect of the present invention includes: a vehicle control method performed by an in-vehicle computer, the method comprising: causing a brake device to apply a brake force and causing the brake device to release the brake force at a time of accelerating a vehicle in accordance with a situation in an advancing direction of the vehicle recognized by a surrounding situation recognizer which is configured to recognize the situation in the advancing direction of the vehicle, and when the vehicle is decelerating, causing the brake device to release the brake force in response to an increase in vehicle speed of the vehicle when the vehicle is subject to acceleration control or an acceleration operation before stopping.

A vehicle control device according to an aspect of the present invention includes: a non-transitory computer-readable storage medium that stores a vehicle control program to be executed by a computer to perform: cause a brake device to apply a brake force and causing the brake device to release the brake force at a time of accelerating a vehicle in accordance with a situation in an advancing direction of the vehicle recognized by a surrounding situation recognizer which is configured to recognize the situation in the advancing direction of the vehicle, and when the vehicle is decelerating, cause the brake device to release the brake force in response to an increase in vehicle speed of the vehicle when the vehicle is subject to acceleration control or an acceleration operation before stopping.

According to the invention disclosed in first to fifth aspects and seventh to tenth aspects, when the vehicle is decelerating, the vehicle can be controlled with good responsiveness by releasing the brake force in response to an increase in vehicle speed of the vehicle when the vehicle has been subjected to acceleration control or an acceleration operation before stopping.

According to the invention disclosed in a sixth aspect, a vehicle can be controlled with a margin when a preceding vehicle starts and then decelerates or is stopped by sufficiently securing an inter-vehicle distance.

### BRIEF DESCRIPTION OF THE DRAWINGS

FIG. 1 is a diagram showing an example of a functional constitution of a vehicle control system.

FIG. 2 is a timing chart showing changes in various states due to a process performed by a vehicle control device.

FIG. 3 is a flowchart showing a flow of the process performed by the vehicle control device.

FIG. 4 is a diagram showing an example of behaviors of a preceding vehicle and a vehicle M in examples and comparative examples.

FIG. 5 is a timing chart showing changes in various states due to the process performed by the vehicle control device when a preceding vehicle starts in a state in which a vehicle is stopped.

FIG. 6 is a diagram showing an example of a functional constitution of a vehicle control system according to a second embodiment.

### DESCRIPTION OF EMBODIMENTS

Embodiments of a vehicle control device, a vehicle control method, and a vehicle control program according to the present invention will be described below with reference to the drawings.

### First Embodiment

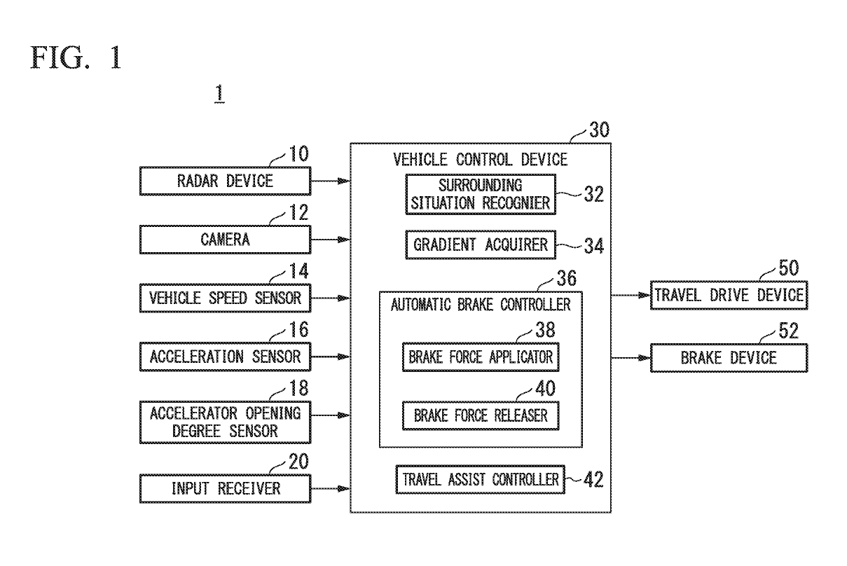

FIG. 1 is a diagram showing an example of a functional constitution of a vehicle control system 1. The vehicle control system 1 includes, for example, a radar device 10, a camera 12, a vehicle speed sensor 14, an acceleration sensor 16, an accelerator opening degree sensor 18, an input receiver 20, a vehicle control device 30, a travel drive device 50, and a brake device 52.

The radar device 10 is provided, for example, near a bumper, a front grill, or the like of a vehicle (hereinafter referred to as “the vehicle”) in which the vehicle control system 1 is mounted. For example, the radar device 10 radiates millimeter waves in a forward direction (an advancing direction) of the vehicle, receives the reflected waves of the radiated millimeter waves that hit and are reflected by an object, and analyzes the received reflected waves, thereby identifying a position of the object. The position of the object includes, for example, at least a distance between the vehicle and the object and may include an orientation, a lateral position, or the like of the object with respect to the vehicle. The radar device 10 detects the position of the object using, for example, a frequency-modulated continuous wave (FM-CW) method and outputs the detection result to the vehicle control device 30.

The camera 12 is a digital camera using a solid-state imaging device such as a charge coupled device and a complementary metal oxide semiconductor (CMOS). The camera 12 is attached to an upper portion of a front windshield, a rear surface of a rearview mirror, or the like. For example, the camera 12 periodically repeats imaging of the area in front of the vehicle and outputs the captured image to the vehicle control device 30. The camera 12 is not limited to one, but a plurality of cameras 12 may be provided in the vehicle and may be a stereo camera including a plurality of cameras.

The vehicle speed sensor 14 includes wheel speed sensors attached to wheels of the vehicle and configured to detect rotational speeds of the wheels and a controller configured to integrate detected values detected by the wheel speed sensors to generate vehicle speed signals. The vehicle speed sensor 14 detects a travel speed of the vehicle and outputs a vehicle speed signal indicating the detected travel speed to the vehicle control device 30.

The acceleration sensor 16 detects an acceleration in forward and rearward (travel) directions of the vehicle and outputs the detected acceleration to the vehicle control device 30. Furthermore, the acceleration sensor 16 may be a biaxial type acceleration sensor.

The accelerator opening degree sensor 18 acquires a degree of opening of the accelerator pedal (an accelerator opening degree) according to an operation with respect to an accelerator pedal serving as an operating tool which is operated by an occupant (a driver) of the vehicle and receives an instruction used to accelerate the vehicle from the occupant of the vehicle. The accelerator opening degree sensor 18 outputs the acquired accelerator opening degree to the vehicle control device 30.

The input receiver 20 is, for example, a dedicated mechanical switch provided near a driver's seat. Furthermore, the input receiver 20 may be a graphical user interface (GUI) switch or the like. The input receiver 20 is provided separately from the accelerator pedal and receives an instruction to accelerate the vehicle from the occupant of the vehicle.

The vehicle control device 30 includes, for example, a surrounding situation recognizer 32, a gradient acquirer 34, an automatic brake controller 36, and a travel assist controller 42. All or some of the surrounding situation recognizer 32, the gradient acquirer 34, the automatic brake controller 36, and the travel assist controller 42 are realized by a hardware processor such as a central processing unit (CPU) executing a program (software). Furthermore, all or some of these may be realized by hardware (a circuit unit; including circuitry) such as a large scale integration (LSI), an application specific integrated circuit (ASIC), a field-programmable gate array (FPGA), and a graphics processing unit (GPU) and may be realized using a combination of software and hardware. Furthermore, functional units included in the vehicle control device 30 may be distributed using a plurality of computer devices. A program executed by processors included in the vehicle control system 1 may be stored in a storage device provided in the vehicle control device 30 in advance and may be downloaded from an external device via an in-vehicle internet facility or the like.

The surrounding situation recognizer 32 acquires a detection result of the radar device 10 and recognizes positions, speeds, or the like of preceding vehicles on the basis of the acquired result. The preceding vehicles are vehicles which travel in the same direction as the vehicle immediately in front of the vehicle in the same lane as the vehicle or are stopped immediately in front of the vehicle, and which are within a predetermined distance from the vehicle. The expression “in the same direction” does not mean that the movement vectors are exactly the same, but deviation in a direction due to a curve or the like may be allowed.

Also, the surrounding situation recognizer 32 may acquire an image captured by the camera 12 and analyze the acquired image to recognize a position, a speed, or the like of a preceding vehicle. In addition, the surrounding situation recognizer 32 may regard a distance from the vehicle as important among positions of preceding vehicles identified by the radar device 10 and regard orientations or lateral positions as important among positions identified through analysis of images captured by the camera 12 and integrate such positions to recognize a position of an object. The vehicle control system 1 includes sensors such as laser radars and ultrasonic sensors in place of (or in addition to) the radar device 10 and the surrounding situation recognizer 32 may recognize a position of an object on the basis of information acquired from such sensors.

Furthermore, the surrounding situation recognizer 32 may detect a position, a speed, or the like of a preceding vehicle on the basis of inter-vehicle communication or information acquired from a sensor configured to detect a vehicle traveling on a road. In this case, the vehicle control system 1 includes a communicator which communicates with another vehicle, a sensor configured to detect a vehicle traveling on a road, or the like.

For example, the gradient acquirer 34 derives and acquires a gradient of a road on which the vehicle is placed. For example, the gradient acquirer 34 derives a gradient of a road surface on the basis of an acceleration in a stopped state obtained by subtracting an acceleration or the like in an advancing direction, which is obtained by differentiating a vehicle speed detected by the vehicle speed sensor 14, from an acceleration output from the acceleration sensor 16. Furthermore, the gradient acquirer 34 may acquire information on a gradient of a road on which the vehicle is placed on the basis of specific positional information obtained by identifying positional information of the vehicle using a global navigation satellite system (GNSS) receiver and map information including information on a gradient of a road. In this case, the vehicle control system 1 includes, for example, a GNSS receiver (not shown) and a storage which stores map information including information on a gradient of a road. The gradient acquirer 34 is an example of an “acquirer” which acquires information of a gradient of a road on which the vehicle is placed.

The automatic brake controller 36 includes, for example, a brake force applicator 38 and a brake force releaser 40. The automatic brake controller 36 is configured to determine a brake force in accordance with a situation in an advancing direction of the vehicle, a behavior of the vehicle, or the like and outputs information associated with the determined brake force to the travel assist controller 42. The brake force applicator 38 outputs a control signal causing the brake device 52 to apply a brake force to the travel assist controller 42 in accordance with a situation in an advancing direction of the vehicle recognized by the surrounding situation recognizer 32. A situation in an advancing direction of the vehicle is a behavior such as a deceleration or a stop of a preceding vehicle, a change in signal used to output information indicating a stop, a traffic situation such as a traffic jam ahead, or the like.

The brake force releaser 40 outputs, to the travel assist controller 42, a control signal causing the brake device 52 to release a brake force instructed to be output by the brake force applicator 38 when the vehicle is accelerated. Release is not limited to instantaneously setting a brake force to zero but includes gradually lowering the brake force. When the vehicle is decelerating and has been subjected to acceleration control or an acceleration operation before stopping, the brake force releaser 40 is configured to cause the brake device 52 to increase a weakening amount per time of a brake force as compared to before a vehicle speed of the vehicle increases when the vehicle speed increases. Details of functions of the brake force applicator 38 and the brake force releaser 40 will be described below.

The travel assist controller 42 controls the vehicle on the basis of a detection result of the vehicle speed sensor 14, a position of an object such as a preceding vehicle recognized by the surrounding situation recognizer 32, a brake force determined by the automatic brake controller 36, or the like. For example, the travel assist controller 42 performs inter-vehicle distance control used to control the travel drive device 50 or the brake device 52 to keep an inter-vehicle distance between the vehicle and the recognized preceding vehicle constant. For example, control in which the travel assist controller 42 accelerates the vehicle in inter-vehicle distance control is an example of “acceleration control.”

The travel assist controller 42 may control the travel drive device 50 to accelerate the vehicle by increasing a driving force upon acquiring an accelerator opening degree of a predetermined extent of opening or more from the accelerator opening degree sensor 18. Furthermore, the travel assist controller 42 may control the travel drive device 50 through an operation of the input receiver 20 by the occupant of the vehicle to accelerate the vehicle by increasing a driving force. At least one of an operation on the accelerator pedal by the occupant of the vehicle or an operation on the input receiver 20 is an example of an “acceleration operation.”

For example, when the vehicle is a car using an internal combustion engine as a power source, the travel drive device 50 includes an engine and an engine electronic controller (ECU) configured to control the engine. The engine ECU adjusts a degree of throttle opening, a shift stage, or the like of the engine and outputs a travel driving force (torque) causing the vehicle to travel in accordance with information input from the travel assist controller 42. Furthermore, the travel drive device 50 includes, for example, an automatic transmission including a torque converter, a metal belt (or a planetary gear), a transmission control device configured to control such functions, or the like. The travel drive device 50 outputs a driving force used to slowly move the vehicle forward on a flat road even when the accelerator pedal is not operated. Such a driving force is referred to as a “creep driving force.”

Note that the vehicle may be an electric car using an electric motor as a power source. In this case, the vehicle includes a travel motor and a motor ECU configured to control the travel motor. When the vehicle includes only a travel motor, the motor ECU adjusts a duty ratio of a pulse width modulation (PWM) signal applied for a travel motor in accordance with information input from travel assist controller 42 and outputs the above-described driving force. Furthermore, the vehicle may be a hybrid car. In this case, the vehicle includes an engine, an engine ECU, a travel motor, and a motor ECU. When the travel drive device 50 includes an engine and a travel motor, both an engine ECU and a motor ECU cooperate with each other to control a driving force in accordance with information input from the travel assist controller 42.

A case in which a power source of the vehicle is an internal combustion engine and the travel drive device 50 includes an automatic transmission will be described below as an example.

The brake device 52 is, for example, an electric servo brake device including a brake caliper, a cylinder configured to transmit a hydraulic pressure to the brake caliper, an electric motor configured to generate a hydraulic pressure in the cylinder, and a brake controller. The brake controller of the electric servo brake device controls the electric motor in accordance with information output by the automatic brake controller 36 so that brake torque according to a brake operation is output to each wheel. The electric servo brake device may include a mechanism configured to transmit a hydraulic pressure generated by an operation of a brake pedal to the cylinder via a master cylinder as a backup. Note that the brake device 52 is not limited to the above-described electric servo brake device but may be an electronically controlled hydraulic brake device. The electronically controlled hydraulic brake device controls an actuator in accordance with information output by the automatic brake controller 36 and transmits a hydraulic pressure of the master cylinder to the cylinder. Furthermore, when the vehicle includes a travel motor, the brake device 52 may include a regenerative brake using the travel motor described with reference to the travel drive device 50.

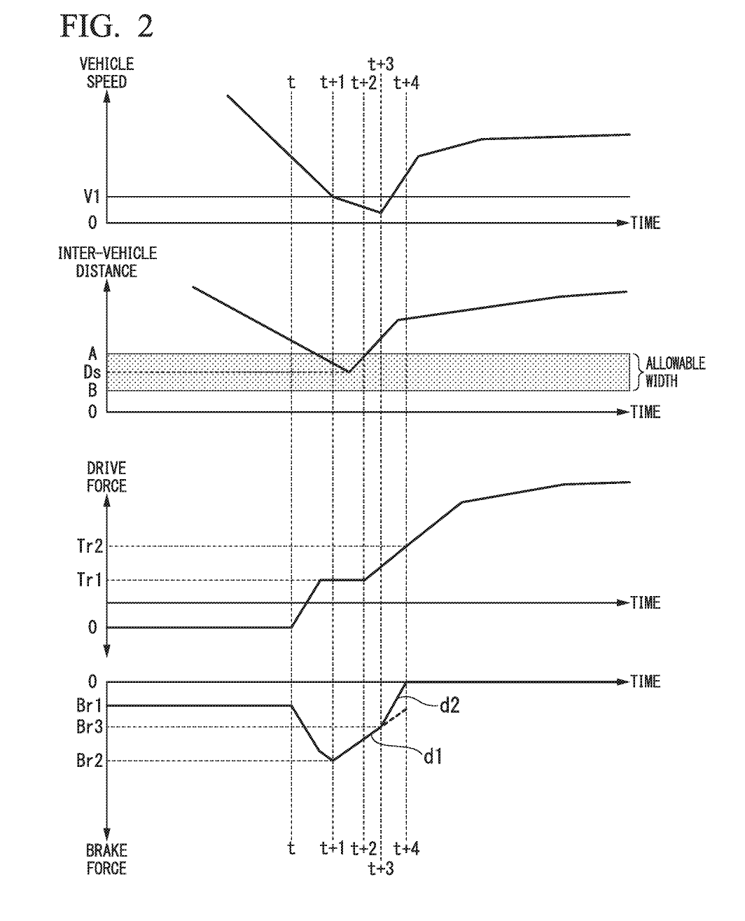

FIG. 2 is a tinting chart showing changes in various states due to a process performed by the vehicle control device 30. In FIG. 2, a case in which the vehicle travels on a road with an upward slope on which the vehicle cannot move forward using a creep driving force will be described as an example. FIG. 2 shows a vehicle speed, an inter-vehicle distance between the vehicle and a preceding vehicle, a driving force output by the vehicle, and a transition of a brake force output by the vehicle according to a time in order from the top. Furthermore, a horizontal axis of FIG. 2 indicates time.

Before a time t, the preceding vehicle starts decelerating. Accordingly, the vehicle decelerates with a predetermined extent of deceleration and thus an inter-vehicle distance between the vehicle and the preceding vehicle decreases. Furthermore, before the time t, the travel assist controller 42 controls the travel drive device 50 such that it is in a fuel cut state and controls a driving force to be output such that it is in a zero state. Before the time t, the brake force applicator 38 is configured to cause the brake device 52 to output a brake force Br1. The brake force is represented by, for example, torque.

At the time t, when an inter-vehicle distance is a predetermined distance or less, the brake force applicator 38 anticipates whether the vehicle will stop due to a decrease in vehicle speed and a decrease in the inter-vehicle distance. When it is anticipated that the vehicle will stop, the travel assist controller 42 stops a fuel cut state and is configured to cause the travel drive device 50 to output a creep driving force Tr1 used to alleviate a forward or rearward acceleration when the vehicle will stop, and the brake force applicator 38 is configured to cause the brake device 52 to output a greater brake force than before to stop the vehicle. The maximum brake force at this time is set to, for example, a brake force Br2.

Between the time t and a time t+1, an inter-vehicle distance is reduced to a value which is less than a distance A with an allowable width and is not less than a distance B with the allowable width at the time of following stop. The allowable width at the time of following stop is set to a range in which the distance A which is originally less than an inter-vehicle distance to be maintained (a target inter-vehicle distance when the vehicle travels at a high speed) is set to be an upper limit and the distance B which is smaller than the distance A and is somewhat larger than zero is set to be a lower limit. The allowable width at the time of following stop is set to be a range in which an avoidance operation such as emergency braking is not required.

At the time t+1, a driving force increases and reaches the creep driving force Tr1. Furthermore, at the time t+1, when a vehicle speed decreases and reaches a vehicle speed V1, the brake force applicator 38 gradually reduces a brake force of the brake device 52 at a weakened speed d1 to stop the vehicle by suppressing a forward or rearward acceleration of the vehicle. Note that, when an inter-vehicle distance decreases and the distance A with the allowable width at the time of following stop before a vehicle speed decreases and reaches the vehicle speed V1, the brake force applicator 38 reduces a strengthened speed of a brake force applied at that timing. Thus, at the time t+1, when the brake force is controlled such that it has a trend of decreasing, it is possible to suppress a sharp change in forward or rearward acceleration of the vehicle.

Between the time t+1 and a time t+2, it is assumed that the preceding vehicle starts immediately after an inter-vehicle distance reaches an inter-vehicle distance Ds. When the preceding vehicle starts, the inter-vehicle distance increases. At the time t+2, the inter-vehicle distance reaches the distance A with the allowable width at the time of following stop.

At the time t+2, the travel assist controller 42 controls the travel drive device 50 to increase a driving force to a predetermined extent from the creep driving force Tr1 to maintain at least a predetermined distance (inter-vehicle distance) from the preceding vehicle to the vehicle. In other words, the travel assist controller 42 outputs a driving force required for following the preceding vehicle to the travel drive device 50 in accordance with a travel state of the preceding vehicle. When an inter-vehicle distance becomes larger than the distance A with the allowable width at the time of following stop so that a driving force used to maintain at least the predetermined distance from the preceding vehicle to the vehicle is output, the inter-vehicle distance is sufficiently secured. The vehicle control device 30 can control the vehicle with a margin by increasing an acceleration after waiting until this state even when the preceding vehicle starts and then decelerates or stops.

Also, at the time t+3, the vehicle changes from a deceleration state to an acceleration state along with an increase in driving force. A brake force at this time is a brake force Br3 with a magnitude between those of the brake force Br1 and the brake force Br2. At the time t+3, the brake force releaser 40 is configured to cause the brake device 52 to increase a weakening amount per time (a weakened speed) of a brake force. For example, the brake force releaser 40 is configured to cause the brake device 52 to increase the weakened speed from the weakened speed d1 to a weakened speed d2.

At a time t+4, a brake force is zero, a driving force is a driving force Tr2, and then the driving force is controlled to maintain at least the predetermined distance from a preceding vehicle to the vehicle. When it is assumed that the vehicle is stopped, the driving force Tr2 is a driving force which is equivalent to a force causing the vehicle to slide down due to a gradient of a road surface (a force causing the vehicle to move backward) when a brake force is zero. The driving force Tr2 is a driving force obtained by taking the errors or variations of various sensors, the weights of loads loaded on the vehicle, or the like, into consideration.

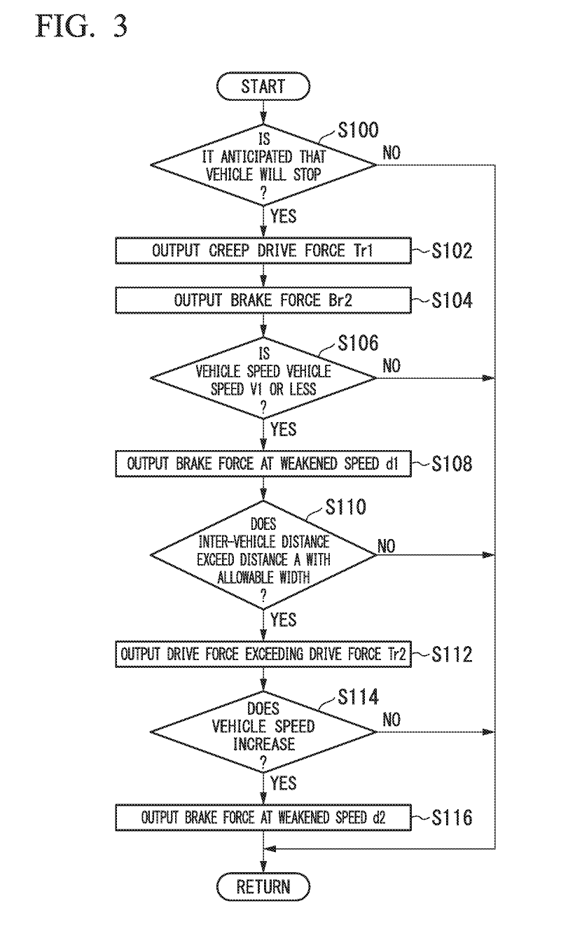

FIG. 3 is a flowchart showing a flow of the process performed by the vehicle control device 30. This flowchart corresponds to, for example, a process carried out when the vehicle decelerates in response to the stop of the preceding vehicle while the vehicle is traveling behind a preceding vehicle.

First, the brake force applicator 38 determines whether it can be anticipated that the vehicle will stop due to a decrease in vehicle speed and a decrease in inter-vehicle distance (Step S100). When it is determined that it cannot be anticipated that the vehicle will stop, a process of one routine of this flowchart ends. When it is determined that it can be anticipated that the vehicle will stop, the travel assist controller 42 stops a fuel cut state and is configured to cause the travel drive device 50 to output a creep driving force Tr1 (Step S102). Furthermore, the brake force applicator 38 is configured to cause the brake device 52 to output a brake force Br2 used to suppress sliding down of the vehicle (Step S104).

Subsequently, the brake force applicator 38 determines whether a vehicle speed is a vehicle speed V1 or less (Step S106). When it is determined that the vehicle speed is the vehicle speed V1 or less, the process of one routine of this flowchart ends. When it is determined that the vehicle speed is the vehicle speed V1 or less, the brake force applicator 38 is configured to cause the brake device 52 to output a brake force of a weakened speed d1 (Step S108).

Subsequently, the brake force applicator 38 determines whether an inter-vehicle distance exceeds a distance A with an allowable width at a time of following stop (Step S110). When it is determined that the inter-vehicle distance does not exceed the distance A with allowable width at the time of following stop, the process of one routine of this flowchart ends. When it is determined that the inter-vehicle distance exceeds the distance A with the allowable width at the time of following stop, the travel assist controller 42 is configured to cause the travel drive device 50 to increase a driving force to exceed a driving force Tr2 (Step S112).

Subsequently, the brake force releaser 40 determines whether a vehicle speed has increased (Step S114). When it is determined that the vehicle speed has not increased, the process of one routine of this flowchart ends. When it is determined that the vehicle speed has increased, the brake force releaser 40 is configured to cause the brake device 52 to output a brake force of a weakened speed d2 having a weakening amount per time of a brake force larger than that of a weakened speed d1 (Step S116). Thus, the process of one routine of this flowchart ends.

Here, when a brake force is gradually decreased at a weakened speed applied before the vehicle speed increases and the driving force reaches the driving force Tr2 which is equivalent to a force causing the vehicle to slide down due to a gradient of a road surface when it is determined that the vehicle speed has increased, a case in which the brake device 52 is controlled to accelerate release of a brake force may be considered.

In this case, a driving force before reaching the driving force Tr2 is canceled out due to a brake force and starting of the vehicle may be delayed in some cases. In other words, responsiveness to a change in situation in an advancing direction of the vehicle may deteriorate in some cases.

On the other hand, the vehicle control device 30 according the embodiment can control the brake device 52 to accelerate alleviation of a brake force used to cancel out a driving force in response to an increase in vehicle speed even before the driving force Tr2 is reached to improve responsiveness at a time of starting.

Note that, although there can also be a case in which a sum value of a driving force and a brake force used to suppress sliding down of the vehicle is computationally insufficient depending on control in the embodiment, the vehicle can start with good responsiveness without sliding down because an inertial force is exerted.

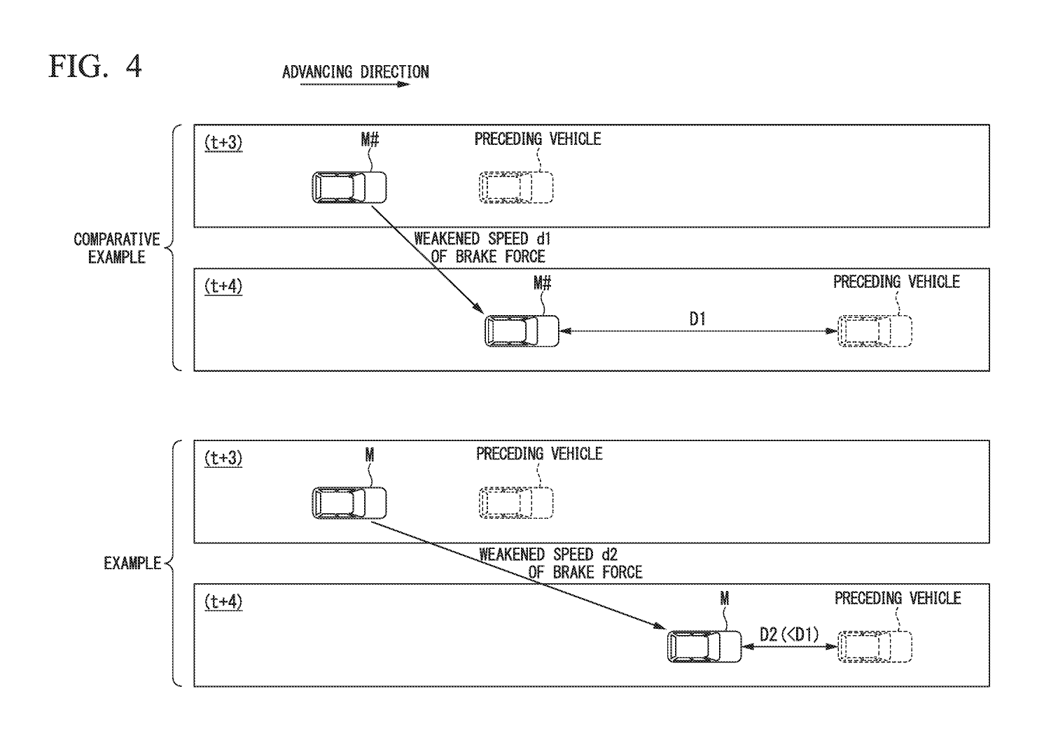

FIG. 4 is a diagram showing an example of behaviors of a preceding vehicle and the vehicle M (the vehicle M# in comparative examples) in the examples and comparative examples. FIG. 4 shows a comparative example at a time t+3, a comparative example at a time t+4, an example at a time t+3, and an example at a time t+4 corresponding to the times of the timing chart of FIG. 2 in order from the top in the drawing. At the times t+3 of the comparative example and the example, since a driving force and a brake force to be output are the same, there is no difference between behaviors of the vehicle M and the vehicle M#.

On the other hand, at the time t+4, in the comparative example, an inter-vehicle distance between the vehicle M# and a preceding vehicle is a distance D1, and in the example, an inter-vehicle distance between the vehicle M and a preceding vehicle is a distance D2 smaller than the distance D1. This is because, between the time t+3 and the time t+4, in the comparative example, a brake force with the same weakened speed as an immediately preceding weakened speed is output, an extent to which a driving force is canceled out is larger than that of the example, and a degree of acceleration of the vehicle is smaller than that of the example, but in the example, a brake force is output at a weakened speed lower than an immediately preceding weakened speed, the extent to which a driving force is canceled out is smaller than that of the comparative example, and the degree of acceleration of the vehicle is larger than that of the comparative example. For this reason, in this embodiment, responsiveness at a time of starting is improved as compared to the comparative example.

Also, although a case in which, when the vehicle travels behind a preceding vehicle, the vehicle starts before decelerating and being stopped has been described with reference to FIGS. 2 and 3 as an example, the present invention is not limited to a case in which the vehicle travels behind the preceding vehicle, but the same process may also be performed in the vehicle when the vehicle accelerates again in a case in which traffic lights in front of the vehicle indicate a stop signal (a red signal), the vehicle is decelerating, and the traffic lights indicate a proceed signal (a green signal) before stopping.

To apply this to the timing chart of FIG. 2, a timing at which traffic lights indicate a stop signal corresponds to before the time t. A timing at which traffic lights indicate a proceed signal corresponds to a time at which an inter-vehicle distance Ds has been reached. Furthermore, in the above-described example, since there is no concept of an inter-vehicle distance, a driving force is controlled to rise from the driving force Tr1 to the driving force Tr2 immediately after traffic lights indicate a proceed signal.

Also, to apply this to the flowchart of FIG. 3, at Step S100, the brake force applicator 38 determines whether it can be anticipated that the vehicle will stop due to a red signal on the basis of the recognition suit of the surrounding situation recognizer 32. When it is determined that it can be anticipated that the vehicle will stop, the process proceeds to the process of Step S102. In addition, when it is determined that it cannot be anticipated that the vehicle will stop, the process of one routine of this flowchart ends. Furthermore, at Step S110, the brake force applicator 38 determines whether traffic lights indicate a proceed signal on the basis of the recognition result of the surrounding situation recognizer 32. When it is determined that the traffic lights indicate the proceed signal, the process proceeds to the process of Step S112. In addition, when it is determined that the traffic lights do not indicate the proceed signal, the process of one routine of this flowchart ends.

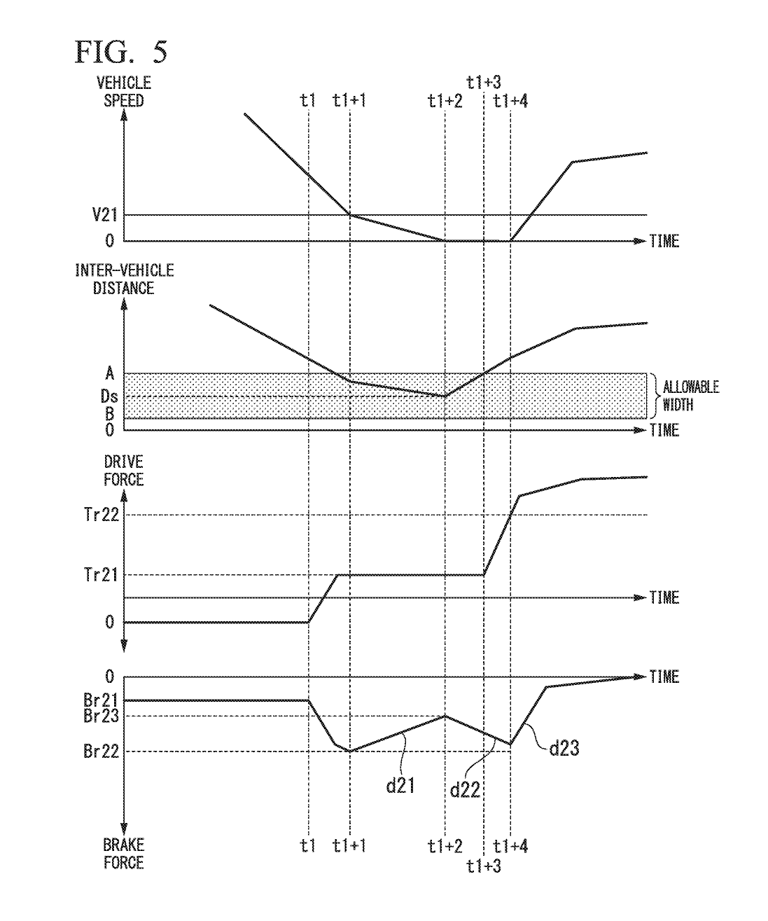

Note that, although a case in which the preceding vehicle starts when the vehicle is decelerating has been described in the first embodiment, since a case in which the preceding vehicle starts in a state in which the vehicle is topped is not mentioned, such a case will be described using FIG. 5 as a comparative example.

FIG. 5 is a timing chart showing changes in various states due to the process performed by the vehicle control device 30 when the preceding vehicle starts in a state in which the vehicle is stopped. In FIG. 5, a case in which the preceding vehicle starts in a state in which the vehicle is stopped on a road with an upward slope in which the vehicle cannot move forward using a creep driving force will be described as an example. FIG. 5 shows the vehicle speed, the inter-vehicle distance between the vehicle and a preceding vehicle, the driving force output by the vehicle, and the transition of a brake force output by the vehicle according to a time in order from the top. Furthermore, the horizontal axis of FIG. 5 indicates time.

Before a time t1, the preceding vehicle started decelerating. Accordingly, the vehicle decelerates with a predetermined extent of deceleration and thus an inter-vehicle distance between the vehicle and the preceding vehicle decreases. Furthermore, before the time t1, the travel assist controller 42 controls the vehicle such that it is in a fuel cut state and controls the driving force to be output such that it is in a zero state. Before the time t1, the brake force applicator 38 is configured to cause the brake device 52 to output a brake force Br21.

At the time t1, when an inter-vehicle distance is a predetermined distance or less, the brake force applicator 38 anticipates whether the vehicle will stop due to a decrease in vehicle speed and a decrease in the inter-vehicle distance. When it is anticipated that the vehicle stop, the travel assist controller 42 stops a fuel cut state and is configured to cause the travel drive device 50 to output a creep driving force Tr21 used to alleviate a forward or rearward acceleration when the vehicle will stop, and the brake force applicator 38 is configured to cause the brake device 52 to output a greater brake force than before to stop the vehicle. This brake force is used to stop the vehicle. The maximum brake force at this time is set to, for example, a brake force Br22.

Between the time t1 and a time t1+1, an inter-vehicle distance is reduced to a value which is less than a distance A with an allowable width and is not less than a distance B with an allowable width at a time of following stop.

At a time t1+1, a driving force increases and reaches the creep driving force Tr21. At the time t1+1, when a vehicle speed decreases and reaches a vehicle speed V21, since the brake force applicator 38 stops the vehicle by suppressing a forward or rearward acceleration of the vehicle, the brake force applicator 38 gradually reduces a brake force of the brake device 52 at a weakened speed d21. Note that, when the inter-vehicle distance decreases and reaches the distance A with the allowable width at the time of following stop before the vehicle speed decreases and reaches the vehicle speed V21, the brake force applicator 38 reduces a strengthened speed of a brake force applied at that timing. Thus, at the time t1+1, when the brake force is controlled such that it has a trend of decreasing, it is possible to suppress a sharp change in forward or rearward acceleration of the vehicle.

Between the time t1+1 and a time t1+2, it is assumed that the preceding vehicle is stopped. When the preceding vehicle is stopped, a vehicle speed thereof is zero.

At the time t1+2, it is assumed that the preceding vehicle starts. Accordingly, an inter-vehicle distance increases from the inter-vehicle distance Ds. Furthermore, at the time t1+2, the brake force applicator 38 gradually increases a brake force of the brake device 52 at a strengthened speed d22. In this way, at the time t1+2 at which the inter-vehicle distance Ds has been reached, the brake force applicator 38 is configured to cause the brake device 52 to output a brake force at the strengthened speed d22 until a driving force exceeds the driving force Tr22 as will be described below so that the vehicle can be started while sliding down of the vehicle is more reliably suppressed. Note that, between the time t1+2 and a time t1+4, an output of a brake force may be constant (a zero slope).

At a time t1+3, the travel assist controller 42 controls the travel drive device 50 to increase a driving force to a predetermined extent from the driving force Tr21 to maintain at least the predetermined distance from the preceding vehicle to the vehicle. In other words, the travel assist controller 42 is configured to cause the travel drive device 50 to output a driving force required for following the preceding vehicle in accordance with a travel state of the preceding vehicle.

At the time t1+4, the vehicle changes from a deceleration state to an acceleration state along with an increase in driving force. Moreover, at the time t1+4, a driving force is the driving force Tr22 and then the driving force is controlled to maintain at least the predetermined distance from the preceding vehicle to the vehicle. When it is assumed that the vehicle is stopped, and the driving force Tr22 is a driving force which is equivalent to a force causing the vehicle to slide down due to a gradient of a road surface when a brake force is zero. The driving force Tr22 is a driving force obtained by taking errors or variations of various sensors, weights of loads loaded on the vehicle, or the like into consideration. The driving force Tr22 is an example of a “predetermined value” in the claims. At the time t1+4, the brake force releaser 40 is configured to cause the brake device 52 to output a brake force at a weakened speed d23 when the driving force Tr22 has been reached and the vehicle accelerates.

As described above, in the comparative example, when the preceding vehicle starts in a state in which the vehicle is stopped on a road with an upward slope in which the vehicle cannot move forward using a creep driving force, the vehicle control device 30 releases a brake force when a driving force of the vehicle exceeds a predetermined value due to acceleration control or an acceleration operation.

According to the vehicle control system according to the first embodiment described above, when the vehicle is decelerating and has been subjected to acceleration control or an acceleration operation before stopping, the brake force releaser 40 is configured to cause the brake device 52 to increase a weakening amount per time of a brake force as compared to before a vehicle speed of the vehicle increases when the vehicle speed increases so that the vehicle can be controlled with good responsiveness.

### Second Embodiment

A second embodiment will be described below. A case in which a vehicle control device 30 is mounted in a vehicle and supports a driver's operation has been described in the first embodiment. On the other hand, a vehicle control system 1A according to the second embodiment is equipped with an automatic operation control device 60 and increases a weakening amount per time of a brake force when a vehicle speed has increased as compared to before the vehicle speed increases, in a case in which the vehicle control system 1A performs an automatic operation, in which at least one of speed control and steering control is automatically performed, on the vehicle and performs acceleration control or an acceleration operation on the vehicle before the vehicle is stopped while the vehicle is decelerating when the automatic operation is being performed on the vehicle. Here, differences from the first embodiment will be mainly described and a description of functions and the like in common with the first embodiment will be omitted.

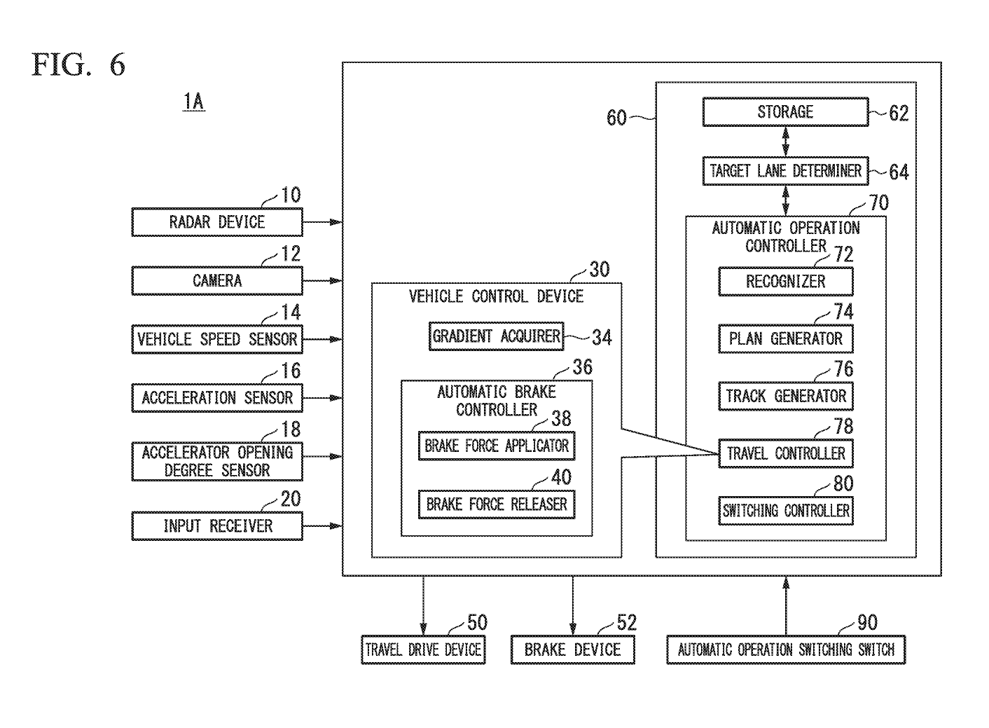

FIG. 6 is a diagram showing an example of a functional constitution of the vehicle control system 1A according to the second embodiment. The vehicle control system 1A includes an automatic operation control device 60 and an automatic operation switching switch 90 in addition to a radar device 10, a camera 12, a vehicle speed sensor 14, an acceleration sensor 16, an accelerator opening degree sensor 18, an input receiver 20, a travel drive device 50, and a brake device 52. The automatic operation control device 60 includes, for example, a storage 62, a target lane determiner 64, and an automatic operation controller 70. The storage 62 stores, for example, information such as high-precision map information target lane information, and action plan information. The storage 62 is realized by a read only memory (ROM), a random access memory (RAM), a hard disk drive (HDD), a flash memory, or the like. A program executed by processors included in the vehicle control system 1A may be stored in the storage 62 in advance and may be downloaded from an external device via an in-vehicle Internet facility or the like.

The target lane determiner 64 is realized by, for example, a micro-processing unit (MPU) or the like. The target lane determiner 64 divides a route provided from a navigation device into a plurality of blocks (for example, divides such a route for every 100 [m] in a vehicle advancing direction of the vehicle) and determines a target lane for every block with reference to the high-precision map information. For example, the target lane determiner 64 determines the number of lanes of a lane in which the vehicle travels from the leftmost lane. For example, when there are branch points, joining points, and the like along the route, the target lane determiner 64 determines a target lane so that the vehicle can travel along a reasonable travel route used to move to a branch destination. A target lane determined by the target lane determiner 64 is stored in the storage 62 as target lane information.

The automatic operation controller 70 includes, for example, a recognizer 72, a plan generator 74, a track generator 76, a travel controller 78, and a switching controller 80.

The recognizer 72 recognizes a relative position of the vehicle with respect to a travel lane and provides the recognized relative position to the target lane determiner 64. Furthermore, the recognizer 72 recognizes positions, speeds, accelerations, and the like of surrounding vehicles near the vehicle on the basis of information input from the radar device 10 and the camera 12.

The plan generator 74 sets a start point of an automatic operation and/or a target point of the automatic operation. The plan generator 74 generates an action plan in a section between such a start point and the target point of the automatic operation. For example, the action plan is composed of a plurality of events to be performed sequentially. Events include, for example, a deceleration event in which the vehicle is decelerated, an acceleration event in which the vehicle is accelerated, a lane keep event in which the vehicle is driven without deviating from a travel lane, a lane change event in which a travel lane is changed, an event of following a preceding vehicle, and the like. Information indicating an action plan generated by the plan generator 74 is stored in the storage 62 as action plan information.

The track generator 76 determines a travel mode from any of constant speed travel, following travel, low-speed following travel, deceleration travel, curve travel, obstacle avoidance travel, lane change travel, joining travel, branch travel, and the like and generates track candidates on the basis of the determined travel mode.

The travel controller 78 controls the travel drive device 50 or the brake device 52 so that the vehicle passes through a track generated by the track generator 76. The switching controller 80 switches between an automatic operation mode and a manual operation mode on the basis of a signal input from the automatic operation switching switch 90. Furthermore, the travel controller 78 has the same functions as the vehicle control device 30 according to the above-described first embodiment. In other words, as a function of controlling the travel drive device 50 or the brake device 52, the brake device 52 is configured to increase a weakening amount per time of a brake force as compared to before the vehicle speed of the vehicle increases when the vehicle speed increases and the vehicle is subject to acceleration control or an acceleration operation before stopping while decelerating. In this case, since the recognizer 72 is provided, the surrounding situation recognizer 32 may be omitted. Furthermore, since an automatic operation is performed by the automatic operation controller 70, the travel assist controller 42 may also be omitted.

According to the vehicle control system 1A according to the second embodiment described above, when the effects of the first embodiment are attained and an automatic operation mode is set, user convenience is further improved because the vehicle travels autonomously.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a surrounding situation recognizer configured to recognize a situation in an advancing direction of a vehicle; and
an automatic brake controller configured to cause a brake device to apply a brake force in accordance with the situation in the advancing direction of the vehicle recognized by the surrounding situation recognizer and is configured to cause the brake device to release the brake force at a time of accelerating the vehicle, in which
when the vehicle is decelerating, the automatic brake controller is configured to cause a brake device to release the brake force in response to an increase in vehicle speed of the vehicle when the vehicle is subject to acceleration control or an acceleration operation before stopping.

2. The vehicle control device according to claim 1, further comprising:
an acquirer is configured to acquire information on a gradient of a road on which the vehicle is placed,
wherein the automatic brake controller is configured to cause the brake device to apply a brake force used to suppress backward movement of the vehicle when the vehicle is located on an upward slope.

3. The vehicle control device according to claim 2, wherein the automatic brake controller is configured to cause the brake device to apply a brake force to correspond to behavior of an object in an advancing direction of the vehicle which is recognized by the surrounding situation recognizes and is configured to cause the brake device to release the brake force in response to an increase in vehicle speed of the vehicle when the acceleration control or the acceleration operation is performed on the vehicle in response to a start of acceleration of the object.

4. The vehicle control device according to claim 3, wherein the automatic brake controller is configured to cause, when the vehicle is stopped, the brake device to release the brake force when a driving force of the vehicle exceeds a predetermined value due to the acceleration control or the acceleration operation, and
is configured to cause, before the vehicle is stopped, the brake device to release the brake force in response to an increase in vehicle speed of the vehicle when the acceleration operation or the acceleration control is performed on the vehicle.

5. The vehicle control device according to claim 4, wherein the automatic brake controller configured to cause the brake device to apply a brake force to stop the vehicle to correspond to a stop of a preceding vehicle located in the advancing direction of the vehicle and traveling in the same direction as the vehicle which is recognized by the surrounding situation recognizer.

6. The vehicle control device according to claim 5, wherein the automatic brake controller is configured to determine that the preceding vehicle has started when a distance from the vehicle to the preceding vehicle is a predetermined distance or more.

7. The vehicle control device according to claim 1, further comprising:
an acquirer configured to acquire information on a gradient of a road on which the vehicle is placed,
the automatic brake controller is configured to cause the brake device to release the brake force before a power source of the vehicle outputs a driving force, which is equivalent to a force causing the vehicle to move backward caused due to the upward slope, to start the vehicle when the vehicle is subject to the acceleration control or the acceleration operation before stopping while decelerating.

8. The vehicle control device according to claim 1, wherein the brake force is gradually released after the vehicle has been subjected to the acceleration control or the acceleration operation before stopping while decelerating and increases a weakening amount per time of the brake force as compared to before a vehicle speed of the vehicle increases.

9. A vehicle control method performed by an in-vehicle computer, the method comprising:
causing a brake device to apply a brake force and causing the brake device to release the brake force at a time of accelerating a vehicle in accordance with a situation in an advancing direction of the vehicle recognized by a surrounding situation recognizer which is configured to recognize the situation in the advancing direction of the vehicle, and
when the vehicle is decelerating, causing the brake device to release the brake force in response to an increase in vehicle speed of the vehicle when the vehicle is subject to acceleration control or an acceleration operation before stopping.

10. A non-transitory computer-readable storage medium that stores a vehicle control program to be executed by a computer to perform:
cause a brake device to apply a brake force and causing the brake device to release the brake force at a time of accelerating a vehicle in accordance with a situation in an advancing direction of the vehicle recognized by a surrounding situation recognizer which is configured to recognize the situation in the advancing direction the vehicle, and
when the vehicle is decelerating, cause the brake device to release the brake force in response to an increase in vehicle speed of the vehicle when the vehicle is subject to acceleration control or an acceleration operation before stopping.
